(19) United States
(12) Patent Application Publication
(10) Pub. No.: US 2015/0193896 A1
(43) Pub. Date: Jul. 9, 2015

(54) MANAGING TITLE RISK OF PATENT ASSETS

(71) Applicant: TVG, LLC, Beaverton, OR (US)

(72) Inventor: Howard Skaist, Portland, OR (US)

(21) Appl. No.: 14/594,051

(22) Filed: Jan. 9, 2015

Related U.S. Application Data
(60) Provisional application No. 61/925,382, filed on Jan. 9, 2014.

(51) Int. Cl. G06Q 50/18; G06Q 10/06

(52) U.S. Cl. CPC G06Q 50/184; G06Q 10/0635

(57) ABSTRACT

Briefly, embodiments of methods and/or systems for managing title risks of patent assets are described.

### BACKGROUND

1. Field

This disclosure relates to managing risks associated with title of patent assets.

2. Information

In certain types of situations, such as transactions involving patents and/or patent applications, having a mechanism to assess title risk with respect to one or more assets may be desirable; however, doing so may be expensive, time consuming and/or, in some situations, even unresolvable.

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is an illustration of an embodiment of a computing platform;

FIG. 2 is an illustration of an embodiment of a system;

FIG. 3 is a flow diagram of an embodiment of a method; and

FIG. 4 is an illustration of an embodiment of a network.

Reference is made in the following detailed description to accompanying drawings, which form a part hereof, wherein like numerals may designate like parts throughout to indicate corresponding and/or analogous components. It will be appreciated that components illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from claimed subject matter. It should also be noted that directions and/or references, for example, such as up, down, top, bottom, and so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

With advances in technology, it has become more typical to employ distributed computing approaches in which portions of a problem, such as signal processing of signal samples, for example, may be allocated among computing devices, including one or more clients and/or one or more servers, via a computing and/or communications network, for example. A network may comprise two or more network devices and/or may couple network devices so that signal communications, such as in the form of signal packets and/or frames (e.g., comprising one or more signal samples), for example, may be exchanged, such as between a server and a client device and/or other types of devices, including between wireless devices coupled via a wireless network, for example.

An example of a distributed computing system comprises the Hadoop distributed computing system, which employs a map-reduce type of architecture. In this context, the terms map-reduce architecture and/or similar terms are intended to refer a distributed computing system implementation for processing and/or for generating large sets of signal samples employing a parallel, distributed process performed over a network of individual computing devices. A map operation and/or similar terms refer to processing of signals to generate one or more key-value pairs and to distribute the one or more pairs to the computing devices of the network. A reduce operation and/or similar terms refer to processing of signals via a summary operation (e.g., such as counting the number of students in a queue, yielding name frequencies). A system may employ such an architecture for processing by marshalling distributed servers, running various tasks in parallel, and managing communications and signal transfers between various parts of the system, in an embodiment. As mentioned, one non-limiting, but well-known example comprises the Hadoop distributed computing system. It refers to an open source implementation of a map-reduce type architecture, but may include other aspects, such as the Hadoop distributed file system (HDFS). In general, therefore, Hadoop and/or similar terms refer to an implementation scheduler for executing large processing jobs using a map-reduce architecture.

In this context, the term network device refers to any device capable of communicating via and/or as part of a network and may comprise a computing device. While network devices may be capable of sending and/or receiving signals (e.g., signal packets and/or frames), such as via a wired and/or wireless network, they may also be capable of performing arithmetic and/or logic operations, processing and/or storing signals (e.g., signal samples), such as in memory as physical memory states, and/or may, for example, operate as a server in various embodiments. Network devices capable of operating as a server, or otherwise, may include, as examples, dedicated rack-mounted servers, desktop computers, laptop computers, set top boxes, tablets, netbooks, smart phones, wearable devices, integrated devices combining two or more features of the foregoing devices, the like or any combination thereof. As mentioned, signal packets and/or frames, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term coupled is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

A network may also include now known, and/or to be later developed arrangements, derivatives, and/or improvements, including, for example, past, present and/or future mass storage, such as network attached storage (NAS), a storage area network (SAN), and/or other forms of computing and/or device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as computing and/or communication protocols (e.g., network protocols), may interoperate within a larger network. In this context, the term sub-network and/or similar terms, if used, for example, with respect to a network, refers to the network and/or a part thereof. Sub-networks may also comprise links, such as physical links, connecting and/or coupling nodes, such as to be capable to transmit signal packets and/or frames between devices of particular nodes, including wired links, wireless links, or combinations thereof. Various types of devices, such as network devices and/or computing devices, may be made available so that device interoperability is enabled and/or, in at least some instances, may be transparent to the devices. In this context, the term transparent refers to devices, such as network devices and/or computing devices, communicating via a network in which the devices are able to communicate via intermediate devices of a node, but without the communicating devices necessarily specifying one or more intermediate devices of one or more nodes and/or may include communicating as if intermediate devices of intermediate nodes are not necessarily involved in communication transmissions. For example, a router may provide a link and/or connection between otherwise separate and/or independent LANs. In this context, a private network refers to a particular, limited set of network devices able to communicate with other network devices in the particular, limited set, such as via signal packet and/or frame transmissions, for example, without a need for re-routing and/or redirecting transmissions. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet, for example. Although signal packet and/or frame transmissions may employ intermediate devices of intermediate nodes to exchange signal packet and/or frame transmissions, those intermediate devices may not necessarily be included in the private network by not being a source or destination for one or more signal packet and/or frame transmissions, for example. It is understood in this context that a private network may provide outgoing network communications to devices not in the private network, but devices outside the private network may not necessarily be able to direct inbound network communications to devices included in the private network.

The Internet refers to a decentralized global network of interoperable networks that comply with the Internet Protocol (IP). It is noted that there are several versions of the Internet Protocol. Here, the term Internet Protocol, IP, and/or similar terms, is intended to refer to any version, now known and/or later developed of the Internet Protocol. The Internet includes local area networks (LANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. Here, the term Hypertext Transfer Protocol, HTTP, and/or similar terms is intended to refer to any version, now known and/or later developed. It is likewise noted that in various places in this document substitution of the term Internet with the term World Wide Web (Web') may be made without a significant departure in meaning and may, therefore, not be inappropriate in that the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. The Internet and/or Web has evolved to a public, self-sustaining facility that may be accessible to tens of millions of people or more worldwide. Also, in an embodiment, and as mentioned above, the terms “WWW” and/or “Web” refer to a part of the Internet that complies with the Hypertext Transfer Protocol. The Internet and/or the Web, therefore, in this context, may comprise an service that organizes stored content, such as, for example, text, images, video, etc., through the use of hypermedia, for example. A HyperText Markup Language (“HTML”), for example, may be utilized to specify content and/or to specify a format for hypermedia type content, such as in the form of a file and/or an “electronic document,” such as a Web page, for example. An Extensible Markup Language (“XML”) may also be utilized to specify content and/or format of hypermedia type content, such as in the form of a file or an “electronic document,” such as a Web page, in an embodiment. Of course, HTML and/or XML are merely example languages provided as illustrations. Furthermore, HTML and/or XML (and/or similar terms) is intended to refer to any version, now known and/or later developed of these languages. Likewise, claimed subject matter is not intended to be limited to examples provided as illustrations, of course.

As used herein, the term “Web site” and/or similar terms refer to a collection of related Web pages. Also as used herein, “Web page” and/or similar terms refer to any electronic file and/or electronic document, such as may be accessible via a network, including by specifying a URL for accessibility via the Web, in an example embodiment. As alluded to above, in one or more embodiments, a Web page may comprise content coded using one or more languages, such as, for example, markup languages, including HTML and/or XML, although claimed subject matter is not limited in scope in this respect. Also, in one or more embodiments, application developers may write code in the form of JavaScript, for example, to provide content to populate one or more templates, such as for an application. The term ‘JavaScript’ and/or similar terms are intended to refer to any now known and/or later developed version of this programming language. However, JavaScript is merely an example programming language. As was mentioned, claimed subject matter is not intended to be limited to examples and/or illustrations.

As used herein, the terms “entry”, “electronic entry”, “document”, “electronic document”, “content”, “digital content”, “item”, and/or similar terms are meant to refer to signals and/or states in a physical format, such as a digital signal and/or digital state format, e.g., that may be perceived by a user if displayed, played and/or otherwise executed by a device, such as a digital device, including, for example, a computing device, but otherwise might not necessarily be perceivable by humans (e.g., in a digital format). Likewise, in this context, content (e.g., digital content) provided to a user in a form so that the user is able to perceive the underlying content itself (e.g., hear audio or see images, as examples) is referred to, with respect to the user, as ‘consuming’ content, ‘consumption’ of content, ‘consumable’ content and/or similar terms. For one or more embodiments, an electronic document may comprise a Web page coded in a markup language, such as, for example, HTML (hypertext markup language). In another embodiment, an electronic document may comprise a portion or a region of a Web page. However, claimed subject matter is not intended to be limited in these respects. Also, for one or more embodiments, an electronic document and/or electronic entry may comprise a number of components. Components in one or more embodiments may comprise text, for example, in the form of physical signals and/or physical states (e.g., capable of being physically displayed). Also, for one or more embodiments, components may comprise a graphical object, such as, for example, an image, such as a digital image, and/or sub-objects, such as attributes thereof, which, again, comprise physical signals and/or physical states (e.g., capable of being physically displayed). In an embodiment, content may comprise, for example, text, images, audio, video, and/or other types of electronic documents and/or portions thereof, for example.

Also as used herein, one or more parameters may be descriptive of a collection of signal samples, such as one or more electronic documents, and exist in the form of physical signals and/or physical states, such as memory states. For example, one or more parameters, such as referring to an electronic document comprising an image, may include parameters, such as time of day at which an image was captured, latitude and longitude of an image capture device, such as a camera, for example, etc. In another example, one or more parameters relevant to content, such as content comprising a technical article, may include one or more authors, for example. Claimed subject matter is intended to embrace meaningful, descriptive parameters in any format, so long as the one or more parameters comprise physical signals and/or states, which may include, as parameter examples, name of the collection of signals and/or states (e.g., file identifier name), technique of creation of an electronic document, purpose of an electronic document, time and date of creation of an electronic document, logical path of an electronic document (or portion thereof), encoding formats and/or standards used for encoding an electronic document, and so forth.

Signal packets and/or frames, also referred to as signal packet transmissions and/or signal frame transmissions, may be communicated between nodes of a network, where a node may comprise one or more network devices and/or one or more computing devices, for example. As an illustrative example, but without limitation, a node may comprise one or more sites employing a local network address. Likewise, a device, such as a network device and/or a computing device, may be associated with that node. A signal packet and/or frame may, for example, be communicated via a communication channel and/or a communication path, such as comprising a portion of the Internet and/or the Web, from a site via an access node coupled to the Internet. Likewise, a signal packet and/or frame may be forwarded via network nodes to a target site coupled to a local network, for example. A signal packet and/or frame communicated via the Internet and/or the Web, for example, may be routed via a path comprising one or more gateways, servers, etc. that may, for example, route a signal packet and/or frame substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

In particular implementations, a network protocol for communicating between devices may be characterized, at least in part, substantially in accordance with a layered description, such as the so-called Open Systems Interconnection (OSI) seven layer approach and/or description. A network protocol refers to a set of signaling conventions, such as for computing and/or communications transmissions, for example, as may take place between and/or among devices in a network, typically network devices; for example, devices that substantially comply with the protocol and/or that are substantially compatible with the protocol. In this context, the term “between” and/or similar terms are understood to include “among” if appropriate for the particular usage and vice-versa. Likewise, in this context, the terms “compatible with”, “comply with” and/or similar terms are understood to include substantial compliance and/or substantial compatibility.

Typically, a network protocol, such as protocols characterized substantially in accordance with the aforementioned OSI description, has several layers. These layers may be referred to here as a network stack. Various types of transmissions, such as network transmissions, may occur across various layers. A lowest level layer in a network stack, such as the so-called physical layer, may characterize how symbols (e.g., bits and/or bytes) are transmitted as one or more signals (and/or signal samples) over a physical medium (e.g., twisted pair copper wire, coaxial cable, fiber optic cable, wireless air interface, combinations thereof, etc.). Progressing to higher-level layers in a network protocol stack, additional operations may be available by initiating network transmissions that are substantially compatible and/or substantially compliant with a particular network protocol at these higher-level layers. For example, higher-level layers of a network protocol may, for example, affect device permissions, user permissions, etc.

A virtual private network (VPN) may enable a remote device to more securely (e.g., more privately) communicate via a local network. A router may allow network communications in the form of network transmissions (e.g., signal packets and/or frames), for example, to occur from a remote device to a VPN server on a local network. A remote device may be authenticated and a VPN server, for example, may create a special route between a local network and the remote device through an intervening router. However, a route may be generated and/or also regenerated if the remote device is power cycled, for example. Also, a VPN typically affects a single remote device.

For a variety of reasons, pricing of patent assets may not necessarily result from pure market forces, such as supply and demand. For example, intrusion by third parties, such as insurance companies, government entities, and/or so forth, may affect a properly functioning market. There may also be other reasons for markets to not operate in accordance with supply and demand, in particular, if market forces are not driving prices. The term market-driven and/or similar terms, if used with another term, like the term price, (thus, for this specific example, market-driven price) refers to an estimate, here an estimate of price, as would result if market forces, such as supply and demand, were in equilibrium or were reasonably close to equilibrium. For example, in an ideal market, an item should be over consumed if prices are reduced relative to market-driven prices or under consumed if prices are higher relative to market-driven prices. However, this dynamic may not always hold true for a market related to patent assets for reasons that may not always be entirely clear.

Most entrepreneurs, such as those having an appreciable investment interest in a small, medium, or large-sized business concern, may typically pursue tactics for reducing risks associated with operating a business, particular one that employs technology to some extent, for example. Variables such as changing regulatory environments, shifting markets, effects of new technologies on product or service offerings, and so forth, may confound even the most seasoned business professionals. As a result, business owners and/or company officers may turn to patent assets in an effort to at least partially have some effect on at least some of these variables and/or to enhance company value. Patent assets may, for example, assist in keeping competitors at bay by way of excluding competitors from making, using, and/or selling certain products. Patent assets may also represent value that can be converted into liquid capital through royalties, licensing revenues, and/or outright sale of patent assets.

However, assets that are mispriced may present some amount of risk to those who participate in a market for those assets. Typically, of course, it is considered desirable, if possible, to reduce risk. Thus, those seeking to purchase or sell patent assets, such as, for example, in connection with a business that employs technology, such as suggested previously, or to generate value, as also previously suggested, may find it desirable if risk is capable of being reduced. One approach to reducing risk may comprise outright purchase of insurance, if insurance is available. For example, in other areas in which property is bought or sold, such as real estate, it is common to purchase title insurance; however, for a variety of reasons, including perhaps because patent assets are not well-understood, patent title insurance may not generally be available. Instead, therefore, in situations involving a transaction of patent assets, parties typically engage services of one or more attorneys and/or otherwise perform a significant amount of due diligence to verify title with respect to one or more patent assets.

Instead, however, claimed subject matter provides an approach to appropriate pricing of title insurance for patent assets, despite potential market imperfections, such as described above with non-limiting examples, so that patent title insurance may become more readily available and/or so that title risk may be handled without necessarily the significant investment of resources that is currently employed to verify title.

It is noted that, in general, for a particular measurement of a characteristic capable of being measured, whether temperature, pressure, voltage, current, or price, for example, a typical measurement model employed is that a measurement taken comprises a sum of at least two components, a deterministic component, which in an ideal sense, comprises a value sought as a result of taking one or more measurements, and a random component, which may have a variety of sources that may be challenging to quantify accurately. Thus, a statistical model may be used. A large number of measurements may be collected, for example, to better estimate a deterministic component, such as by reduction of random (e.g., statistical) variation (e.g., variance), for example. Likewise, where measurements vary, some portion of a variance may be explained as a deterministic component while some portion of a variance may be explained as a random component. Typically, it is desirable to have variance associated with and/or modeled as statistically random factors be relatively small, if feasible.

Along these lines, a variety of techniques have come into use so that measurements may be processed to better estimate an underlying deterministic component, as well as realized random components, typically. These techniques may vary with a particular situation. Typically, however, more complex problems involve more complex techniques. In this regard, it is noted, pricing of title insurance may be considered similar to estimation of other measurable characteristics. Thus, for example, measurements may be collected. Employing a model permits collected measurements to be processed to estimate an underlying deterministic component. Although a given estimate may not be a perfect estimate, in general, it is expected that on average an estimate may better reflect an underlying deterministic component if random components that may be included in measurements are considered. Practically speaking, of course, it is desirable to be able to generate, such as through estimation approaches, a meaningful model of processes affecting measurements, whether random or not.

In some situations, nonetheless, as indicated, potential influences may be complex. Therefore, seeking to understand appropriate factors to consider for generating estimates may be particularly challenging. For example, here, as only a few examples, influences may include, for example, changes in patent law, changes in technology, general changes in economic conditions, etc.

Thus, reasonable approaches to reduce statistical variance may include any one of a variety of approaches, such as analysis of variance (ANOVA) techniques, regression, machine learning, etc. In such situations, it also may not be unusual to employ heuristics in connection with generating estimates. Heuristics refers to use of experience related approaches that may reflect realized processes and/or realized results, such as in connection with use of historical measurements, for example, that provide acceptable performance. Heuristics, for example, may be employed in situations, such as this, where more analytical approaches may be overly complex and/or nearly intractable.

Consistent with the foregoing, one approach to estimation may involve recognizing that in the context of assessing risk to title to one or more patent assets, title may be of consequence in situations in which claims of a patent asset are infringed. In general, and appropriately, conventionally, risk to title and risk of infringement may be evaluated independently. However, both are elements of consequence in connection with understanding value of a patent asset, for example. That is, for a patent asset to be of value, title to the patent and infringement of the patent are both called for. Likewise, returning to the discussion provided above, a deterministic component and a random component for title to the patent and infringement of the patent, respectively, may be involved in relation to patent value, for example. Likewise, in general, as to the random components, in general, it may be assumed, appropriately, that they are uncorrelated. That is, uncertainty as to whether or not title is valid should not statistically influence uncertainty as to whether or not that particular patent (e.g., the patent claims thereof) is infringed.

Continuing along these lines, in general, if summing random components, such as A and B, for example, that are uncorrelated, one technique often used is to take the square root of the sum of squares, e.g., substantially in accordance with the following, for example:

(A²+B²)^{1/2}

where A and B represent respective uncertainties, such as risk as to title and risk as to infringement, as described previously. Likewise, along similar lines, in the example above, if A is significantly greater than B (e.g., A dominates B), the sum of squares may be approximated or estimated by B squared alone. Taking a similar approach here, if title risk, for example, were estimated and infringement risk, for example, were estimated, and if infringement risk were to dominate title risk, it might be appropriate to employ infringement risk as an estimate of overall risk, without necessarily considering (e.g., attempting to better estimate) title risk. It is noted here that likelihood of patent infringement and patent infringement risk, though related, may not be precisely the same. Patent infringement risk refers to uncertainty as to the likelihood of patent infringement. Thus, the two may be reasonably and even at times heavily correlated in various situations. For example, likelihood of patent infringement may provide an indication regarding appropriate scale (e.g., magnitude) of patent infringement risk. For example, and consistent with the foregoing, if, in an embodiment, as described in more detail later, a patent title risk metric were computed, patent infringement risk and in some cases likelihood of patent infringement may be employed at least in part in connection with computation of a patent title risk metric.

Thus, if, for example, engaging in a transaction that involves patent assets, a first inquiry may concern estimating breadth of claimed subject matter and whether one or more of a competitor's products may directly and/or indirectly infringe. Patent assets having broad claims and/or patent assets comprising a family of related patents, which may cover multiple products and/or services offered by competitors, may be valued higher than patent assets having narrow claims covering few, or perhaps no, products and/or services offered by competitors. In some instances, monetary value of patent assets may be affected by other concerns, such as estoppel resulting, at least in part, from statements made, such as on record by an attorney or agent prosecuting a patent application, statements made in declarations by inventors, and/or other factors.

In addition to the above-identified concerns, which may affect breadth of claims of a patent asset, value of a patent asset may be affected by risks related to title (e.g. ownership) to a patent application. For those instances in which a clear chain of title may not be immediately apparent, such as, for example, by searching a database comprising assignment documents at the United States Patent and Trademark Office, by searching UCC filings in various states, by searching company records, and/or by searching records from a company's state of incorporation, etc., a value of a patent asset may be diminished. In some cases, if title to a patent asset can be called into question, even patent assets having ample claim breadth may be less valuable and may represent risk to a purchaser, for example, unless title to the patent asset can be perfected (e.g., validated).

According to one or more implementations, as discussed herein, a system and/or method may be provided for managing risk, such as title risk for one or more patent assets, for example, in transactions involving patent assets. In one embodiment, a computing platform may execute machine-readable instructions resulting in a generation of electrical signals and/or states representing an estimate of likelihood of infringement of rights associated with a patent asset. A computing platform may, based at least in part on an estimate, discount potential risk to title of a patent asset. In other embodiments, a non-transitory storage medium comprising machine-readable instructions stored thereon which are executable by a special-purpose computing apparatus may generate electrical signals and/or states representing an estimate of a likelihood of infringement of rights associated with a patent asset and discount potential risk to title, such as in connection with a transaction based, at least in part, on an estimate of the likelihood.

In certain implementations, for example, a computing platform may compute a title insurance premium as a result of discounting potential risk to title to an invention and/or patent asset. In particular implementations, for example, potential risk to title may comprise one or more defects and/or encumbrances to a title of a patent asset, such as resulting from an unrecorded exclusive or nonexclusive license to make, use, or sell an invention that falls within the scope of the claims of a patent asset. In other implementations, potential risk to title may comprise one or more defects and/or encumbrances, such as resulting from a state or federal government authority, for example, that funded particular inventions claimed by one or more patent assets. Other defects and/or encumbrances may comprise unrecorded assignments of right, title, and/or interest of patent assets, liens against a title to an invention and/or patent asset, agreements to limit manufacture, use, or sale of inventions falling within the claims of a patent asset, etc. However, it should be noted that the aforementioned defects, encumbrances and/or potential risks to title represent a few of numerous possible risks to title, and claimed subject matter is not limited in this respect.

In implementations, a potential title risk metric may be computed and, for example, may be used in formulating a title risk insurance premium. A title risk insurance premium, for example, may be offered to one or more parties of a transaction involving a patent asset as a means of shielding parties from risks associated with defects and/or encumbrances, for example, in title to a patent asset. A potential title risk metric may be computed by one or more processors of a special-purpose computing platform, for example, which may approximate and/or estimate likelihood of infringement of one or more claims of a patent asset, as discussed previously.

As the term is used herein, a “defect” may comprise a circumstance or concern that could, at least in part, cause a title of a patent asset to be declared invalid. As the term is used herein, an “encumbrance” may comprise a limitation that restricts a title holder's ability to control an invention, such as an ability to control making, using, selling, etc. by others that may otherwise be encompassed in one or more claims of a patent asset. A “patent asset,” as the term is used herein, may comprise pending utility or design patent applications, issued or granted utility or design patents, patents undergoing reissue or re-examination proceedings, plant patents, and so forth. A “transaction,” as the term is used herein, may comprise a sale, purchase, exclusive or nonexclusive license, or any other type of transfer or exchange of one or more patents assets.

In particular implementations, for example, for patent assets comprising relatively broad claims, which may represent an increased likelihood of infringement, a relatively high potential title risk metric may be computed. A relatively high potential title risk metric may result, at least in part, in a relatively high patent asset title risk premium offered as a form of insurance to indemnify (e.g., insure) parties of a transaction, for example. For patent assets comprising relatively narrow claims, which may be less likely to be infringed, a relatively low potential title risk metric may be computed. A relatively low potential title risk metric may result, at least in part, in a relatively low patent asset title risk premium offered as a form of insurance to indemnify (e.g., insure) parties of a transaction, for example.

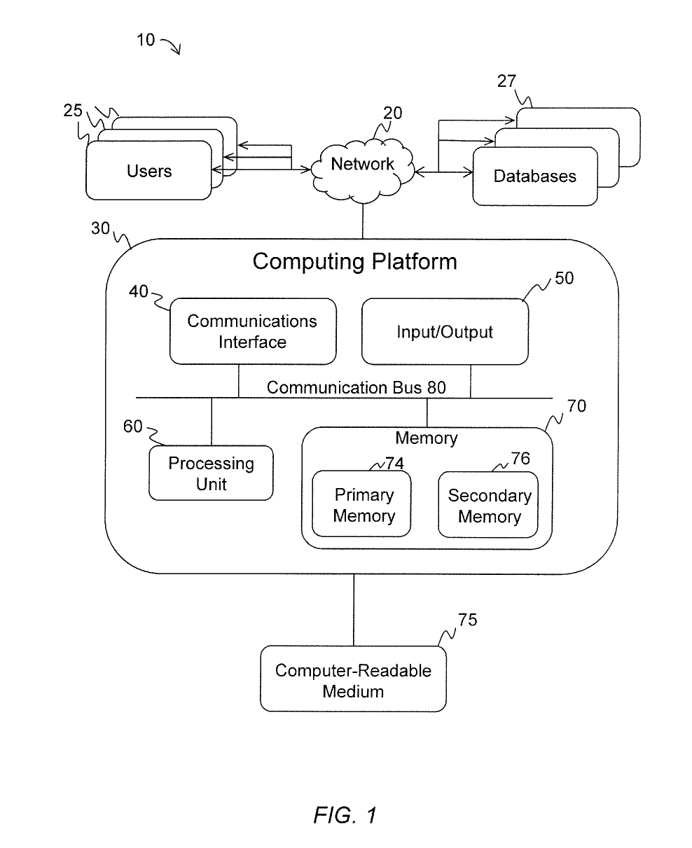

FIG. 1 is an illustration of an embodiment 10 of a computing platform for managing title risk for one or more patent assets. In FIG. 1, computing platform 30 may interface with network 20. Communications interface 40, input/output module 50, processing unit 60, and memory 70, which may comprise primary memory 74 and secondary memory 76, may communicate by way of communication bus 80, for example. In FIG. 1, users 25, which may represent one or more parties, such as engaging in a transaction involving patent assets, for example, may communicate with computing platform 30, such as by way of an Internet connection through network 20. Computing platform 30 may query one or more of databases 27, which represent, for example, an assignment database, such as a patent and trademark office database, a company database, and/or official databases from a business entity's state of incorporation (and/or other states, such as UCC, etc.). Although the computing platform of FIG. 1 shows the above-identified elements, claimed subject matter is not limited to computing platforms having only these elements as other implementations may include alternative arrangements that may comprise additional components, fewer components, or components that function differently while achieving similar results.

Processing unit 60 may be representative of one or more circuits, such as digital circuits, to perform at least a portion of a computing procedure or process. By way of example but not limitation, processing unit 60 may comprise one or more processors, controllers, microprocessors, microcontrollers, application specific integrated circuits, digital signal processors, programmable logic devices, field programmable gate arrays, and the like, or any combination thereof.

Memory 70 may be representative of any storage mechanism. Memory 70 may comprise, for example, primary memory 74 and secondary memory 76, additional memory circuits, mechanisms, or combinations thereof may be used. Memory 70 may comprise, for example, random access memory, read only memory, or one or more storage devices or systems, such as, for example, a disk drive, an optical disc drive, a tape drive, a solid state memory drive, to name just a few examples. Memory 70 may be utilized to store states and/or signals relating to managing risk with respect to title to one or more patent assets, for example. Memory 70 may also comprise a memory controller for accessing computer readable-medium 75 that may carry and/or make accessible content, code, and/or instructions, for example, executable by processing unit 60 or some other controller or processor capable of executing instructions, for example.

Network 20 may comprise one or more communication links, processes, and/or resources to support exchanging communication signals between users 25, databases 27, and/or computing platform 30, for example. By way of example, but not limitation, network 20 may comprise wireless and/or wired communication links, telephone or telecommunications systems, Wi-Fi networks, Wi-MAX networks, the Internet, the web, a local area network (LAN), a wide area network (WAN), or any combination thereof.

The term “computing platform,” as used herein, refers to a system and/or a device that includes a capability to process and/or store signals and/or states. Thus, a computing platform, in this context, may comprise hardware, software, firmware, or any combination thereof (other than software per se). Computing platform 30, as depicted in FIG. 1, is merely one such example, and it is not intended that claim scope be limited to this particular example. For one or more embodiments, a computing platform may comprise any of a wide range of digital electronic devices, including, but not limited to, personal desktop or notebook computers, high-definition televisions, digital versatile disc (DVD) players and/or recorders, game consoles, satellite television receivers, cellular telephones, personal digital assistants, mobile audio and/or video playback and/or recording devices, or any combination of the above. Further, unless specifically stated otherwise, a process as described herein, with reference to flow diagrams and/or otherwise, may also be executed and/or affected, in whole or in part, by a computing platform.

Memory 70 may store cookies relating to one or more users, such as users 25, for example, and may also comprise a computer-readable medium that may carry and/or make accessible content, code and/or instructions, for example, executable by processing unit 60 or some other controller or processor capable of executing instructions, for example. Users 25 may make use of an input device, which may comprise a computer mouse, stylus, track ball, keyboard, or any other device capable of receiving an input, such as an input from user 25.

A computer-readable (storage) medium, such as computer-readable medium 75 of FIG. 1, typically may comprise non-transitory and/or may comprise a non-transitory device. In this context, a non-transitory storage medium may comprise a device that is tangible, meaning that the device has a concrete physical form, although the device may change its physical state. Thus, for example, non-transitory refers to a device remaining tangible despite a change in state.

Users 25 may make use of client resources that may comprise a browser utilized to, e.g., view or otherwise access content, such as, from the Internet, for example. A browser may comprise a standalone application, or an application embedded in or forming at least part of another program or operating system, etc. Client resources may also include or present a graphical user interface. An interface, such as GUI, may comprise, for example, an electronic display screen or various input or output devices. Input devices may comprise, for example, a microphone, a mouse, a keyboard, a pointing device, a touch screen, a gesture recognition system (e.g., a camera or other sensor), or any combinations thereof, etc., just to name a few examples. Output devices may comprise, for example, a display screen, speakers, tactile feedback/output systems, or any combination thereof, etc., just to name a few examples.

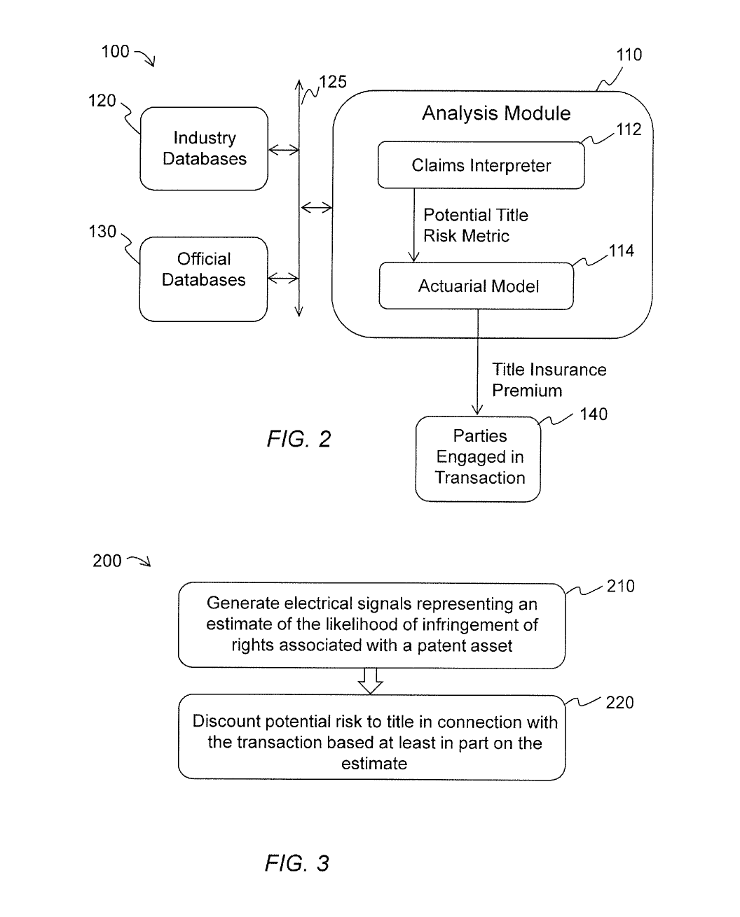

FIG. 2 is a diagram showing an embodiment 100. In FIG. 2, analysis module 110 may receive input signals from industry databases 120 and/or official databases 130 using network 125. In an implementation, industry databases 120 may represent, for example, databases comprising states and/or signals pertaining to actual or potential sales figures for products and/or services that may fall within one or more claims of a patent asset. In one possible example, industry databases 120 may comprise sales figures for communications devices that may include particular memory devices, controllers, memory architectures, and other mechanisms that perform certain functions. Accordingly, industry databases 120 may represent a wide variety of sources, and claimed subject matter is not limited to particular industry databases.

Official databases 130, which may convey signals to analysis module 110 using network 125, may represent a variety of state and federal government title records systems. For example, official databases 130 may comprise the United States Patent and Trademark Office assignment database, and/or official databases from various states, such as California, Illinois, and so forth. In implementations, official databases from states may comprise records systems wherein liens and/or other encumbrances are recorded as security interests against a title to a patent asset, for example. Thus, official databases 130 may represent a variety of federal, state, and local records systems and claimed subject matter is not limited in this respect.

Analysis module 110 may comprise claims interpreter 112 and actuarial model 114. In an implementation, such as FIG. 2, claims interpreter 112 may comprise an evaluation module for estimating a likelihood of infringement of rights associated with a patent asset, for example. Analysis module 110 may represent one or more logical modules or processes executable by way of processing unit 60 of computing platform 30 of FIG. 1, for example, using a non-transitory storage medium comprising machine-readable instructions, such as memory 70 and/or computer-readable medium 75.

In implementations, as an example, claims interpreter 112 may parse one or more claims of a patent asset and evaluate parsed claims against states and/or signals conveyed from industry databases 120 to detect potential infringement of claimed subject matter. Infringement may comprise indirect infringement, which may include infringement by inducement and/or contributory patent infringement, for example, and direct infringement, which may include marketing, sale, and/or commercial use of a service or product encompassed by one or more claims of a patent asset. Infringement may be literal, in which, for example, literal language of one or more claims reads on an infringing product and/or service, or may be nonliteral, such as by equivalents, in which literal language of one or more claims does not read on an infringing product and/or service.

In at least one implementation, claims interpreter 112 may compute approximations of a likelihood of infringement in terms of one or more levels, such as, for example, a first level, a second level, and so forth, of likelihood that a claim may potentially be infringed. For example, if claims interpreter 112 indicates that most or all claims of a particular patent asset are less likely to be infringed, interpreter 112 may generate one or more output signals corresponding to a lower level of potential title risk. If claims interpreter 112 indicates that one or more claims of a particular patent asset are more likely to be infringed, interpreter 112 may generate one or more output signals corresponding to a higher level of potential title risk.

Actuarial model 114, which receives potential title risk metrics from claims interpreter 112, may represent a mathematical model and associated logic that may incorporate risk assumptions substantially in accordance with a patent asset title insurance premium pricing process, for example. In implementations, for example, patent assets having a higher potential title risk metric may result in a higher patent asset title insurance premium. Patent assets having a lower potential title risk metric may result in a lower patent asset title insurance premium. However, in other implementations, other title insurance pricing schemes may be used, and claimed subject matter is not limited in this respect.

In implementations, analysis module 110 may enable more efficient allocation of title insurance premiums among patent assets, such as involved in a transaction. For those patent assets for which infringement may be more likely, a higher title insurance premium may be assessed. For patent assets less likely to be infringed, a lower title insurance premium may be assessed. However, regardless of likelihood that claims of a particular patent asset may be directly or indirectly infringed, for example, title to most or perhaps all patent assets can be insured. By way of patent asset title insurance, parties engaged in a transaction, 140, may, for example, have increased confidence that a least a portion of the entire cost of a transaction may be insured. This may be especially useful if, for example, during an enforcement action (e.g. infringement), a defect to the title to a patent asset were discovered. As a result of such a finding, a purchaser of a patent asset may be insured against financial loss resulting from a defect in the title of an asset.

In implementations, for example, defects and/or encumbrances that may affect title to a patent asset may comprise an encumbrance that limits the scope of the right, title, or interest in a patent asset that can be transferred as a result of a transaction. A defect and/or encumbrance may result, for example, from a failure to assign a patent asset to a funding authority, such as a government entity, educational institution, and/or other funding source that may have rights to inventions conceived and/or identified during a period of performance in accordance with a funding agreement.

A defect and/or encumbrance may result, at least in part, from an unrecorded assignment of a party having an interest in a patent asset. A defect and/or encumbrance may result, at least in part, from a legally valid and enforceable lien against title of a patent asset. Liens may comprise judicial liens, statutory liens, consensual liens, equitable liens, and/or uniform commerce code liens, just to name a few examples. A defect and/or encumbrance may also result, at least in part, from an invalid transfer of title or lack of authority to transfer a title. A defect and/or encumbrance may also result, at least in part, from a risk of foreclosure on a patent asset by a private party, for example, or a public entity, such as a lending institution. It should be mentioned, however, that the aforementioned liens may represent examples of possible defects and/or encumbrances, and claimed subject matter is not limited in this respect.

In implementations, defects and/or encumbrances to title to a patent asset may, at least in part, represent risk to a buyer and/or a seller in a transaction involving a patent asset, as an example. Title to a patent asset may be encumbered and/or have a defect from a risk that an exclusive or nonexclusive license has been granted to an unknown third party, for example. A license may encompass a full scope of claims of a patent asset, for example, or may encompass less than a full scope claims. In implementations, a license may represent a limitation in territory, subject matter, time period, and/or other constraint on the manufacture, use, and/or sale of products and/or services within the scope of one or more claims of a patent asset. It should be noted, however, that other defects and/or encumbrances may also represent risk in a transaction involving a patent asset, for example, and claimed subject matter is not limited in this respect.

FIG. 3 is an illustration of an embodiment 200 of a method. The system embodiment of FIG. 2 may be suitable for performing the method embodiment of FIG. 3, although the method embodiment may be performed using alternate arrangements of components in other implementations. Example implementations may include blocks in addition to those shown and described, fewer blocks, blocks occurring in an order different from FIG. 3, or any combination thereof. In implementations, the method embodiment of FIG. 3 may result, at least in part, from a special-purpose processing unit executing machine-readable instructions from a non-transitory storage medium; however, claimed subject matter is not limited in this respect.

The method embodiment of FIG. 3 begins at block 210, which comprises generating electrical signals and/or states representing an estimate of likelihood of infringement of rights associated with a patent asset. Block 210 may result, at least in part, from an analysis of a scope of claims of a patent asset in view of industry databases which may comprise signals and/or states pertaining to actual or potential sales figures for products and/or services that may fall within the scope of one or more claims of a patent asset. The method embodiment may continue at block 220, which may comprise discounting potential risk to title in connection with a transaction. Block 220 may result, at least in part, from one or more output signals and/or states of block 210 in which a likelihood of infringement of patent rights may be approximated.

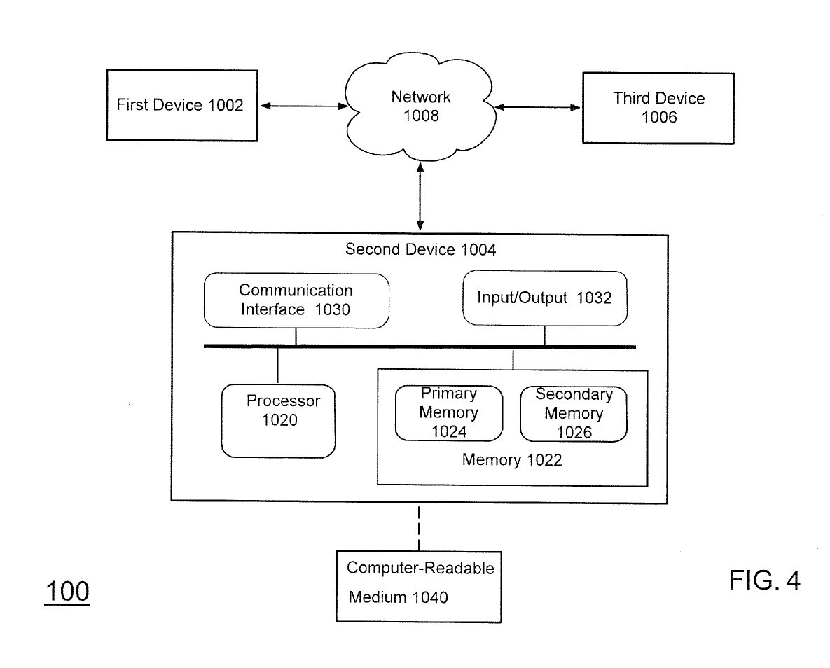

For purposes of illustration, FIG. 4 is an illustration of an embodiment of a system 100 that may be employed in a client-server type interaction, such as described infra. in connection with rendering a GUI via a device, such as a network device and/or a computing device, for example. In FIG. 4, computing device 1002 (‘first device’ in figure) may interface with client 1004 (‘second device’ in figure), which may comprise features of a client computing device, for example. Communications interface 1030, processor (e.g., processing unit) 1020, and memory 1022, which may comprise primary memory 1024 and secondary memory 1026, may communicate by way of a communication bus, for example. In FIG. 4, client computing device 1002 may represent one or more sources of analog, uncompressed digital, lossless compressed digital, and/or lossy compressed digital formats for content of various types, such as video, imaging, text, audio, etc. in the form physical states and/or signals, for example. Client computing device 1002 may communicate with computing device 1004 by way of a connection, such as an internet connection, via network 1008, for example. Although computing device 1004 of FIG. 1 shows the above-identified components, claimed subject matter is not limited to computing devices having only these components as other implementations may include alternative arrangements that may comprise additional components or fewer components, such as components that function differently while achieving similar results. Rather, examples are provided merely as illustrations. It is not intended that claimed subject matter to limited in scope to illustrative examples.

Processor 1020 may be representative of one or more circuits, such as digital circuits, to perform at least a portion of a computing procedure and/or process. By way of example, but not limitation, processor 1020 may comprise one or more processors, such as controllers, microprocessors, microcontrollers, application specific integrated circuits, digital signal processors, programmable logic devices, field programmable gate arrays, the like, or any combination thereof. In implementations, processor 1020 may perform signal processing to manipulate signals and/or states, to construct signals and/or states, etc., for example.

Memory 1022 may be representative of any storage mechanism. Memory 1020 may comprise, for example, primary memory 1022 and secondary memory 1026, additional memory circuits, mechanisms, or combinations thereof may be used. Memory 1020 may comprise, for example, random access memory, read only memory, etc., such as in the form of one or more storage devices and/or systems, such as, for example, a disk drive, an optical disc drive, a tape drive, a solid-state memory drive, etc., just to name a few examples. Memory 1020 may be utilized to store a program. Memory 1020 may also comprise a memory controller for accessing computer readable-medium 1040 that may carry and/or make accessible content, which may include code, and/or instructions, for example, executable by processor 1020 and/or some other unit, such as a controller and/or processor, capable of executing instructions, for example.

Under direction of processor 1020, memory, such as memory cells storing physical states, representing, for example, a program, may be executed by processor 1020 and generated signals may be transmitted via the Internet, for example. Processor 1020 may also receive digitally-encoded signals from client computing device 1002.

Network 1008 may comprise one or more network communication links, processes, services, applications and/or resources to support exchanging communication signals between a client computing device, such as 1002, and computing device 1006 (‘third device’ in figure), which may, for example, comprise one or more servers (not shown). By way of example, but not limitation, network 1008 may comprise wireless and/or wired communication links, telephone and/or telecommunications systems, Wi-Fi networks, Wi-MAX networks, the Internet, a local area network (LAN), a wide area network (WAN), or any combinations thereof.

The term “computing device,” as used herein, refers to a system and/or a device, such as a computing apparatus, that includes a capability to process (e.g., perform computations) and/or store content, such as measurements, text, images, video, audio, etc. in the form of signals and/or states. Thus, a computing device, in this context, may comprise hardware, software, firmware, or any combination thereof (other than software per se). Computing device 1004, as depicted in FIG. 4, is merely one example, and claimed subject matter is not limited in scope to this particular example. For one or more embodiments, a computing device may comprise any of a wide range of digital electronic devices, including, but not limited to, personal desktop and/or notebook computers, high-definition televisions, digital versatile disc (DVD) players and/or recorders, game consoles, satellite television receivers, cellular telephones, wearable devices, personal digital assistants, mobile audio and/or video playback and/or recording devices, or any combination of the above. Further, unless specifically stated otherwise, a process as described herein, with reference to flow diagrams and/or otherwise, may also be executed and/or affected, in whole or in part, by a computing platform.

Memory 1022 may store cookies relating to one or more users and may also comprise a computer-readable medium that may carry and/or make accessible content, including code and/or instructions, for example, executable by processor 1020 and/or some other unit, such as a controller and/or processor, capable of executing instructions, for example. A user may make use of an input device, such as a computer mouse, stylus, track ball, keyboard, and/or any other similar device capable of receiving user actions and/or motions as input signals. Likewise, a user may make use of an output device, such as a display, a printer, etc., and/or any other device capable of providing signals and/or generating stimuli for a user, such as visual stimuli, audio stimuli and/or other similar stimuli.

Regarding aspects related to a communications and/or computing network, a wireless network may couple client devices with a network. A wireless network may employ stand-alone ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including Long Term Evolution (LTE), WLAN, Wireless Router (WR) mesh, 2nd, 3rd, or 4th generation (2G, 3G, or 4G) cellular technology and/or the like. Network access technologies may enable wide area coverage for devices, such as client devices with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra wideband (UWB), 802.11b/g/n, and/or the like. A wireless network may include virtually any type of now known and/or to be developed wireless communication mechanism by which signals may be communicated between devices, between networks, within a network, and/or the like.

Communications between a computing device and/or a network device and a wireless network may be in accordance with known and/or to be developed communication network protocols including, for example, global system for mobile communications (GSM), enhanced data rate for GSM evolution (EDGE), 802.11b/g/n, and/or worldwide interoperability for microwave access (WiMAX). A computing device and/or a networking device may also have a subscriber identity module (SIM) card, which, for example, may comprise a detachable or embedded smart card that is able to store subscription content of a user, and/or is also able to store a contact list of the user. A user may own the computing device and/or networking device or may otherwise be a user, such as a primary user, for example. A computing device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a communication network may be embodied as a wired network, wireless network, or any combinations thereof.

A device, such as a computing and/or networking device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

A computing and/or network device may include and/or may execute a variety of now known and/or to be developed operating systems, derivatives and/or versions thereof, including personal computer operating systems, such as a Windows, iOS, Linux, a mobile operating system, such as iOS, Android, Windows Mobile, and/or the like. A computing device and/or network device may include and/or may execute a variety of possible applications, such as a client software application enabling communication with other devices, such as communicating one or more messages, such as via protocols suitable for transmission of email, short message service (SMS), and/or multimedia message service (MMS), including via a network, such as a social network including, but not limited to, Facebook, LinkedIn, Twitter, Flickr, and/or Google+, to provide only a few examples. A computing and/or network device may also include and/or execute a software application to communicate content, such as, for example, textual content, multimedia content, and/or the like. A computing and/or network device may also include and/or execute a software application to perform a variety of possible tasks, such as browsing, searching, playing various forms of content, including locally stored and/or streamed video, and/or games such as, but not limited to, fantasy sports leagues. The foregoing is provided merely to illustrate that claimed subject matter is intended to include a wide range of possible features and/or capabilities.

A network may also be extended to another device communicating as part of another network, such as via a virtual private network (VPN). To support a VPN, broadcast domain signal transmissions may be forwarded to the VPN device via another network. For example, a software tunnel may be created between a logical broadcast domain, and a VPN device. Tunneled traffic may, or may not be encrypted, and a tunneling protocol may be substantially compliant with and/or substantially compatible with any now known and/or to be developed versions of any of the following protocols: IPSec, Transport Layer Security, Datagram Transport Layer Security, Microsoft Point-to-Point Encryption, Microsoft's Secure Socket Tunneling Protocol, Multipath Virtual Private Network, Secure Shell VPN, another existing protocol, and/or another protocol that may be developed.

A network may communicate via signal packets and/or frames, such as in a network of participating digital communications. A broadcast domain may be substantially compliant and/or substantially compatible with, but is not limited to, now known and/or to be developed versions of any of the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A broadcast domain may employ, for example, TCP/IP, UDP, DECnet, NetBEUI, IPX, Appletalk, other, and/or the like. Versions of the Internet Protocol (IP) may include IPv4, IPv6, other, and/or the like.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involves physical manipulation of physical quantities. Typically, although not necessarily, such quantities may take the form of electrical and/or magnetic signals and/or states capable of being stored, transferred, combined, compared, processed or otherwise manipulated as electronic signals and/or states representing various forms of content, such as signal measurements, text, images, video, audio, etc. It has proven convenient at times, principally for reasons of common usage, to refer to such physical signals and/or physical states as bits, values, elements, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically represented as physical electronic and/or magnetic quantities within memories, registers, and/or other storage devices, transmission devices, and/or display devices of the special purpose computer and/or similar special purpose computing and/or network device. In the context of this particular patent application, as mentioned, the term “specific apparatus” may include a general purpose computing and/or network device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation and/or a physical change and/or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

1. A method of managing risk with respect to a transaction involving a patent asset, comprising:
executing machine-readable instructions to:
generate electrical signals representing an estimate of a likelihood of infringement of rights associated with said patent asset; and
generate electrical signals representing a discount to potential risk to title in connection with said transaction based at least in part on said estimate.

2. The method of claim 1, and further comprising:
executing machine-readable instructions to:
compute a title insurance premium based, at least in part, on said generated electrical signals representing said discount to said potential risk to title.

3. The method of claim 1, wherein said patent asset comprises one or more issued US patents.

4. The method of claim 1, wherein said patent asset comprises one or more pending US patents.

5. The method of claim 1, wherein said infringement comprises:
direct infringement.

6. The method of claim 1, wherein said infringement comprises:
indirect infringement.

7. The method of claim 1, wherein said potential risk to title comprises:
an encumbrance to said title that limits right, title, or interest capable of being conveyed in said transaction.

8. The method of claim 1, wherein said potential risk to title comprises:
a defect resulting, at least in part, from an interest of a funding source.

9. The method of claim 1, wherein said to potential risk to title comprises:
a defect resulting, at least in part, from an unrecorded assignment of an interest in said patent asset.

10. The method of claim 1, wherein said potential risk to title comprises:
a defect resulting, at least in part, from a legally valid and enforceable lien.

11. The method of claim 1, wherein said potential risk to title comprises:
a defect resulting from an invalid transfer of title or lack of authority to transfer title.

12. The method of claim 11, wherein said potential risk to title comprises:
a defect resulting from a risk of foreclosure on said patent asset.

13. The method of claim 1, wherein said potential risk to title comprises:
a defect resulting from an encumbrance resulting, at least in part, from a risk of a license to make, use, or sell, one or more products within the scope of the claims of said patent asset.

14. The method of claim 13, wherein said encumbrance comprises:
an agreement to limit making, using, or selling one or more products within said scope of said claims of said patent asset.

15. An apparatus comprising:
one or more processing units to:
compute an approximation of a likelihood of infringement of one or more claims of a patent asset; and
compute a potential title risk metric of said patent asset based at least in part on said approximation.

16. The apparatus of claim 15, wherein said approximation of said likelihood of infringement comprises at least a first level corresponding to a low likelihood of infringement, and a second level corresponding to a higher likelihood of infringement.

17. The apparatus of claim 16, wherein said one or more processing units assign a first potential title risk metric if said likelihood of infringement corresponds to a first level, and assigns a second potential title risk metric if said likelihood of infringement corresponds to a second level, said second potential title risk metric being greater than said first potential title risk metric.

18. The apparatus of claim 15, wherein said potential title risk metric results from, at least in part, an encumbrance that limits rights that can be exercised by an owner of said patent asset.

19. The apparatus of claim 15, wherein said potential title risk metric results from, at least in part, a defect to said title that could, at least in part, result in said patent asset being declared invalid.

20. An article comprising:
a non-transitory storage medium comprising machine-readable instructions stored thereon which are executable by a special purpose computing apparatus to:
parse one or more claims of a patent asset:
approximate likelihood of infringement of said one or more claims of said patent asset involved in a transaction; and
discount potential risk to title in connection with said transaction based at least in part on said approximated likelihood.

21. The article of claim 20, wherein said non-transitory storage medium further comprises machine-readable instructions stored thereon which are executable by a special purpose computing apparatus to:
receive input signals from one or more industry databases.

22. The article of claim 20, wherein said non-transitory storage medium further comprises machine-readable instructions stored thereon which are executable by a special purpose computing apparatus to:
generate a title insurance premium based, at least in part, on said discounted potential risk.

23. A method comprising:
estimating patent asset title risk and patent infringement risk via a computing device; and
where the estimate of patent infringement risk dominates the estimate of patent asset title risk, using the estimate of patent infringement risk to estimate patent title risk.

24. The method of claim 23, and further comprising determining a patent asset title insurance premium based at least in part on said estimate of patent infringement risk.

25. The method of claim 24, wherein likelihood of patent infringement is employed at least in part to estimate patent infringement risk.

26. The method of claim 23, wherein said estimating comprises executing software instructions on one or more computing devices.

27. The method of claim 26, wherein said estimating patent asset title risk and patent infringement risk includes performing analysis of variance with respect to said risks.

28. The method of claim 26, wherein said one or more computing devices comprises one or more server devices and/or one or more client devices.

29. The method of claim 23, wherein said estimating patent asset title risk and patent infringement risk is executed for a portfolio of over 100 patent assets.

30. The method of claim 23, wherein estimating patent asset title risk and patent infringement risk via a computing device comprises computing a patent title risk metric; and where the estimate of patent infringement risk dominates the estimate of patent asset title risk, using the estimate of patent infringement risk to estimate patent title risk comprises using the estimate of patent infringement risk to compute the patent title risk metric.

31. The method of claim 30, wherein likelihood of patent infringement is employed at least in part to estimate patent infringement risk and wherein using using the estimate of patent infringement risk to estimate patent title risk comprises using likelihood of patent infringement at least in part to compute the patent title risk metric.
